(19) United States
(12) Patent Application Publication
(10) Pub. No.: US 2024/0328218 A1
(43) Pub. Date: Oct. 3, 2024

(54) Automotive Vehicle Door Restraint System

(71) Applicant: Benito Moreno, San Antonio, TX (US)

(72) Inventor: Benito Moreno, San Antonio, TX (US)

(21) Appl. No.: 18/129,404

(22) Filed: Mar. 31, 2023

(51) Int. Cl. E05C 17/36

(52) U.S. Cl. CPC E05C 17/36; E05Y 2900/531

(57) ABSTRACT

A system for restraining outward movement of a door relative to an automotive vehicle body is disclosed. The system includes an automotive vehicle body, a door movably attached to the vehicle body, and a door movement restraint device that employs a body connector, a door connector, and a flexible connecting member detachably connected to the body connector and/or the door connector. The body connector includes a first base section having a first connecting opening for receiving the flexible connecting member and a first attachment section that includes a first attachment hole. The door connector includes a second base section and a second connecting opening for receiving the flexible connecting member and a second attachment section having a second attachment hole. The restraint device can be installed in the vehicle by securing the body connector to the vehicle body and connecting the door connector to the door of the vehicle.

### CROSS REFERENCE TO RELATED APPLICATION

Not Applicable

### STATEMENT RE: FEDERALLY SPONSORED RESEARCH/DEVELOPMENT

Not Applicable

### BACKGROUND

The various aspects and embodiments described herein relate to a system for restraining outward movement of a door relative to an automotive vehicle body using an automotive vehicle door movement restraint device. In an automotive vehicle, there is often a need to restrict the degree of movement of the hinged vehicle door during assembly, use, and/or repair of the vehicle in order to prevent damage to the vehicle and/or a nearby vehicle.

In certain models, there can be problem with actual breakage of the vehicle door hinges, especially on the driver's side of the vehicle due to repeated excessive outward movement of the door. In addition, the excessive movement can cause the door to damage the vehicle body and/or a nearby vehicle.

### SUMMARY

A system for restraining outward movement of a door relative to an automotive vehicle body using an automotive vehicle door movement restraint device is disclosed. The device employs an automotive vehicle connector 1 having a first base section 10 and a first attachment section 15 positioned at an angle to the first base section 10. First base section 10 includes a first connecting opening 5 for receiving a flexible connecting member 70. The first attachment section 15 includes a first attachment hole 20 for mounting the body connector 1 onto the vehicle body. The device also employs a door connector 2 having a second base section 13 and second connecting opening 25 for receiving the flexible connecting member 70. Door connector 2 also includes a second attachment section 12 having a second attachment hole 30. The device further includes a flexible connecting member 70 configured to connect vehicle connector 1 to door connector 2 by means of the first and second connecting openings. The flexible connecting member 70 is configured to be detachably connected to the body connector and/or the door connector.

### BRIEF DESCRIPTION OF THE DRAWINGS

FIG. 1 is a perspective view of an embodiment of a door restraint device showing a vehicle connector joined to a door connector by a connecting member.

FIG. 2 is a perspective view of the body connector.

FIG. 3 is a perspective view of the door connector.

FIG. 4 is a perspective view of the back of the connecting member.

FIG. 5. is a perspective view of the door restraint device attached to a vehicle body.

FIG. 6. is a perspective view of a door attached to a vehicle body.

### DETAILED DESCRIPTION

An automotive vehicle door restraint system disclosed herein includes an automotive vehicle body, a door movably attached to the vehicle body, and a door movement restraint device 45 wherein the device includes a body connector 1, a door connector 2, and a flexible connecting member 70 configured to connect vehicle connector 1 to the door connector 2. The flexible connecting member 70 is configured to be detachably connected to the body connector and/or the door connector.

Body connector 1 includes a first base section 10 and a first attachment section 15 positioned at a first angle A to base section 10. The base section 10 of vehicle connector 1 also includes a first connecting opening 5 for receiving the connecting member 70. First attachment section 15 includes a first attachment hole 20 for mounting the vehicle connector 1 onto a vehicle frame.

Door connector 2 includes a second base section 13 and a second attachment section 12 integral with the second base section 13 and positioned at a second angle B. Second base section 13 includes a second connecting opening 25 for receiving flexible connecting member 70. Second attachment section 12 includes a second attachment hole 30 for mounting the door connector 2 onto a vehicle door.

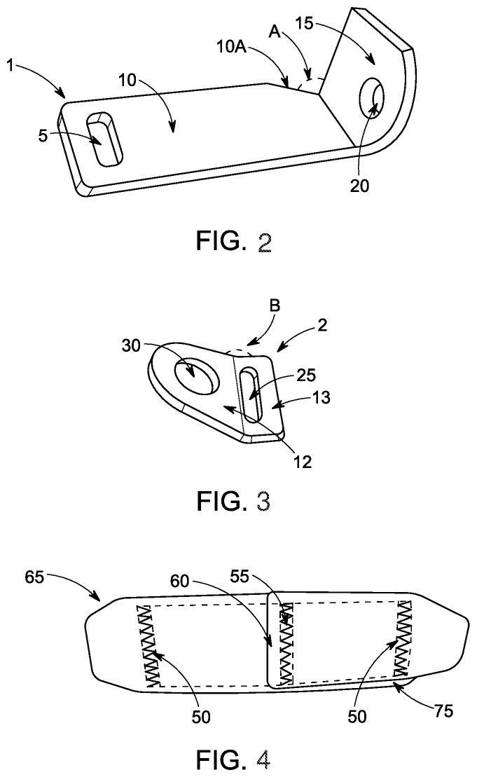

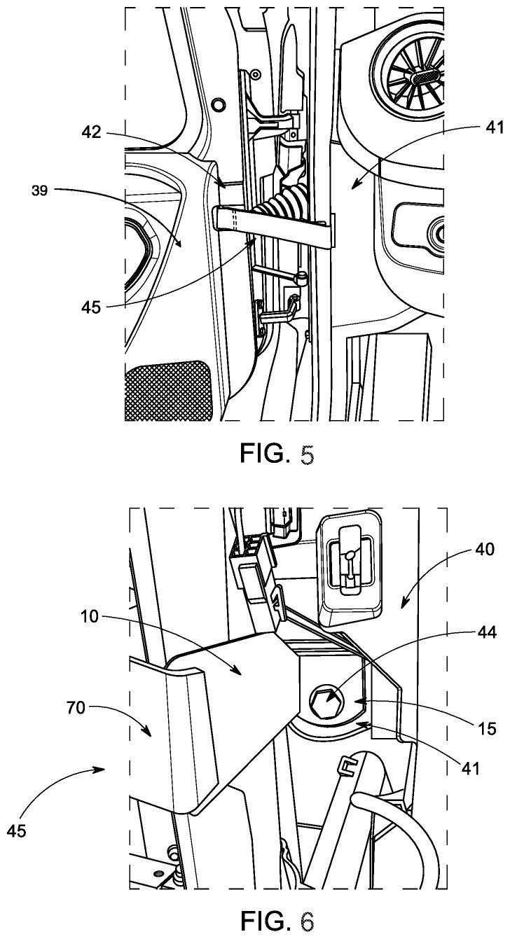

In an embodiment of the restraint device, body connector 1 and door connector 2 of the restraint device are shown in FIGS. 2A and 2B respectively. A first attachment section 15 is located at a first angle A to tapered section 10A of first base section 10. Angle A may vary over a wide range depending on the characteristics of the vehicle. An appropriate amount for angle A such as about 90° C. an be readily determined by those skilled in the art. A second attachment section 12 is located at a second angle B to second base section 13. As with angle A, angle B may vary over a wide range depending on the characteristics of the vehicle. An appropriate amount for angle B such as about 27° C. an be readily determined by those skilled in the art.

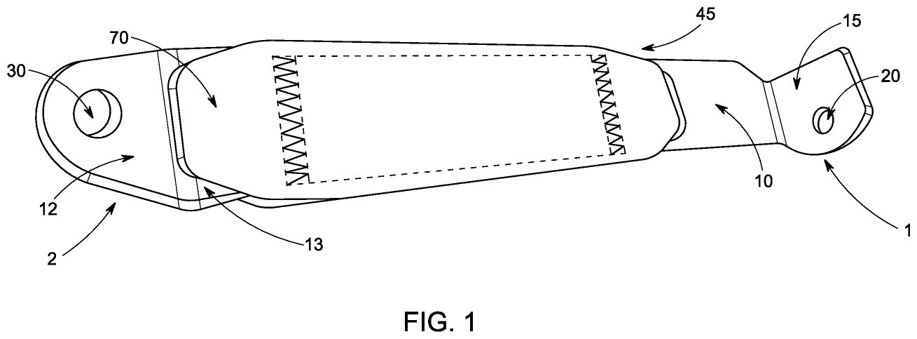

The device further includes a flexible connecting member 70 connecting vehicle connector 1 to door connector 2. Connecting member 70 is configured to be detachably connected to either the body connector or the door connector or detachably connected to both connectors as shown in FIG. 1 so that the member can be unfastened or disconnected from either connector without damage to either connector. As a result, the restraint device disclosed herein can be conveniently used with a variety of different connecting members. This is convenient because it enables the use of the same connectors with a variety of connecting members that have different lengths for different sizes of automotive vehicles.

In an embodiment of the restraint device, the flexible connecting member includes a first end and a second end wherein the connecting member is connected to the body connector 1 by means of a first loop formed by first end section through first connecting opening 5 and attachment of first end section to the flexible connecting member. The connecting member is attached to door connector 2 by means of a second loop formed by second end section through second connecting opening 25 and attachment of the second end section to the flexible connecting member.

In the embodiment of the restraint device shown in FIG. 2C, the flexible connecting member includes a first end 60 and a second end 75 wherein the connecting member is attached to the body connector 1 by means of a loop formed by first or second end section through first connecting opening 5 and through second connecting opening 25 and attachment of the first end section to the second end section to each other.

The ends of the flexible connecting member can be attached to the member or to each other by fastening means determined by one skilled in the art to secure the member to the connectors during use, depending upon the characteristics of the connecting member, size of the vehicle, the level of restraint needed, etc. The fastening means may be adjustable so that the length of the connecting member between the connectors can be adjusted. Fastening means are known in the art such as stitching, snap fasteners, grommets, hoop-and-loop fasteners, hook-and-pile fasteners, touch fasteners. Velcro® Brand fasteners are commercially available hoop-and-loop fasteners.

The flexible connecting member is detachably connected to either or both connectors so that the member can be removed without damage to the connector(s). When removed, the connecting member may or may not be damaged depending on the attachment of the end sections to the connecting member or to each other. For example, when stitching is used, the connecting member may be cut for convenient removal.

In the embodiment shown in FIG. 1, the connecting member 70 is a strap. FIG. 2C shows the back 65 of connecting member 70 wherein first end section 60 and second end section 75 of the strap overlap and are secured by stitching 55. Also shown is additional stitching 50 near the attachments to the connectors.

With reference to the drawings, body connector 1 of the door movement restraint device 45 includes base section 10 wherein the first connecting opening is a slot 5 as shown in FIG. 2A. Door connector 2 includes base section 13 wherein the second connecting opening is a slot 25 shown in FIG. 2B.

Suitable materials for the connectors can be determined by one skilled in the art. For example, connectors 1 and 2 may be made from materials such as steel or polymers. The connectors can be made by metal fabrication methods known in the art to be suitable for the materials used. For example, a steel base section and openings can be made by known methods such as punching, folding, cutting or machining methods. A base section made from polymers and its openings can be made by known molding techniques.

Flexible connecting member 70 may be a strap made of materials such as fabric, webbing and the like that are made from a suitable material such as nylon. Dimensions of the strap can be determined by one skilled in the art in view of the particular vehicle, door, their proximity, etc.

An embodiment of the door movement restraint device 45 shown in FIG. 1 may be made by joining vehicle connector 1 to door connector 2 by means of a flexible strap 70 having overlapping end sections 60 and 75 shown in FIG. 2C.

For example, first end section 75 can be inserted into slot 5 in first section 10. Second end section 60 can then be inserted into slot 25 of section 13 and joined so that, as shown in FIG. 2C, the end sections overlap and are secured by sewing stitches 55 to form a loop as shown in FIGS. 1 and 2C. Additional stitching 50 near the attachments to the connectors can be employed to secure the connectors within the loop. Alternatively, each end section can be folded after passing through the slots and stitched to secure each end section to connecting member 70.

The vehicle door movement restraint device 45 can be installed in a vehicle in a number of ways depending upon the particular configuration of the vehicle body and the door movably attached to the vehicle body. To mount an embodiment of device 45 shown in FIGS. 3A and 3B, body connector 1 can be installed onto the driver side of the vehicle body 40 by removing the driver side dashboard endcap to access the body subframe 41. Body connector 1 then is secured to vehicle body subframe 41 by means of a fastener through first attachment hole 20, e.g., the factory bolt 44 holding body subframe 41 to the vehicle body 40 can be reused to secure body connector 1 through first attachment hole 20.

Door connector 2 can be installed onto the attached door 39 by removing the door panel to access the door frame 42. A bolt hole can be drilled into the door frame 42 to fasten door connector 2 to the door frame 42 by means of a fastener such as a bolt through second attachment hole 30.

The above description is given by way of example, and not limitation. Given the above disclosure, one skilled in the art could devise modifications and variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. An automotive vehicle door movement restraint system comprising, an automotive vehicle body, a vehicle door movably attached to the vehicle body, and a vehicle door movement restraint device cooperatively connected to the automotive vehicle body and to the vehicle door for restraining outward movement of the vehicle door relative to the automotive vehicle body comprising, in combination, a body connector, a door connector, and a flexible connecting member configured to connect the body connector to the door connector, wherein the connecting member is configured to be detachably connected to the body connector and/or to the door connector;
wherein the body connector comprises a first base section having a first connecting opening for receiving a flexible connecting member and a first attachment section integral with the first base section and positioned at a first angle to the first base section wherein the first attachment section includes a first attachment hole to enable mounting and securing of the body connector onto the automotive vehicle body, and
wherein the door connector comprises a second base section having a second connecting opening for receiving the flexible connecting member and wherein door connector includes a second attachment section integral with the second base section and positioned at a second angle to the second base section wherein the second attachment section includes a second attachment hole to enable mounting of the door connector onto the vehicle door movably connected to the automotive vehicle body.

2. The system of claim 1 wherein the flexible connecting member includes a first end and a second end, wherein the flexible connecting member is detachably connected to the body connector by means of a first loop formed by placement of the first end section through the first connecting opening and attachment of the first end section to the flexible connecting member; and wherein the flexible connecting member is detachably connected to the door connector by means of a second loop formed by placement of the second end section through the second connecting opening and attachment of the second end section to the flexible connecting member.

3. The system of claim 2 wherein the end sections of the flexible connecting member are attached to the flexible connecting member by one or more of stitching, snap fastener, grommet, hoop-and-loop fastener, hook-and-pile fastener, and/or touch fastener.

4. The system of claim 1 wherein the flexible connecting member includes a first end and a second end wherein the flexible connecting member is detachably connected to the body connector and the door connector by means of a loop formed by placement of the first end section through the first connecting opening and by placement of the second end section through the second connecting opening and attachment of the first end section to the second end section.

5. The system of claim 4 wherein the first and second end sections of the flexible connecting member are attached to each other by one or more of stitching, snap fastener, grommet, hoop-and-loop fastener, hook-and-pile fastener, and/or touch fastener.

6. The system of claim 1 wherein the first base section includes a tapered section proximate to first attachment section.

7. The system of claim 6 wherein the first attachment section is located at an angle of about 90° to the tapered section.

8. The system of claim 1 wherein the second attachment section is located at an angle of about 27° to the second base section.

9. An automotive vehicle door movement restraint device for restraining outward movement of an automotive vehicle door movably connected to an automotive vehicle body comprising a body connector, a door connector, and a flexible connecting member configured to connect the body connector to the door connector, wherein the flexible connecting member is configured to be detachably connected to the body connector and/or to the door connector;
wherein the body connector comprises an elongated base section having a first connecting opening for receiving a first end of the flexible connecting member and a first attachment section integral with the first base section and positioned at a first angle to the base section wherein the first attachment section includes a first attachment hole to enable mounting of the vehicle connector onto the automotive vehicle body; and
wherein the door connector comprises a second base section having a second connecting opening for receiving the flexible connecting member wherein the door connector includes a second attachment section integral with the second base section and positioned at a second angle to the second base section wherein a second attachment section includes a second attachment hole to enable mounting of the door connector onto the automotive vehicle door movably connected to the automotive vehicle body.

10. The restraint device of claim 9 wherein the flexible connecting member includes a first end and a second end wherein the flexible connecting member is detachably connected to the body connector by means of a first loop formed by placement of first end section through the first attachment hole and attachment of the first end section to the flexible connecting member and wherein the connecting member is detachably connected to the door connector by means of a second loop formed by placement of the second end section through the second attachment hole and attachment of the second end section to the flexible connecting member.

11. The restraint device of claim 10 wherein the first and second end sections of the flexible connecting member are attached to the flexible connecting member by one or more of stitching, snap fastener, grommet, hoop-and-loop fastener, hook-and-pile fastener, and/or touch fastener.

12. The restraint device of claim 9 wherein the flexible connecting member includes a first end and a second end wherein the flexible connecting member is detachably connected to the body connector and the door connector by means of a loop formed by the first end section or second end section through the first connecting opening and the second connecting opening and attachment of the first end section to the second end section.

13. The restraint device of claim 12 wherein the first and second end sections of the flexible connecting member are attached to each other by one or more of stitching, snap fastener, grommet, hoop-and-loop fastener, hook-and-pile fastener, and/or touch fastener.

14. The restraint device of claim 9 wherein the first base section includes a tapered section proximate to the first attachment section.

15. The restraint device of claim 14 wherein the first attachment section is located at an angle of about 90° to the tapered section.

16. The restraint device of claim 9 wherein the second attachment section is located at an angle of about 27° to the second base section.

17. The restraint device of claim 9 wherein the flexible connecting member is configured to be detachably connected to the body connector and the door connector.

18. The system of claim 1 wherein the flexible connecting member is configured to be detachably connected to the body connector and the door connector.
